(19) United States
(12) Patent Application Publication
(10) Pub. No.: US 2021/0259462 A1
(43) Pub. Date: Aug. 26, 2021

(54) BURNER FOR ROTISSERIE GRILL

(71) Applicants: Guilherme Kunz, Orlando, FL (US); Gilberto Lucas, Denver, CO (US)

(72) Inventors: Guilherme Kunz, Orlando, FL (US); Gilberto Lucas, Denver, CO (US)

(21) Appl. No.: 17/154,563

(22) Filed: Jan. 21, 2021

Related U.S. Application Data
(60) Provisional application No. 62/980,590, filed on Feb. 24, 2020.

(51) Int. Cl. A47J 37/06; A47J 37/04

(52) U.S. Cl. CPC A47J 37/0629; A47J 37/041

(57) ABSTRACT

A burner for a rotisserie grill, including a rectilinear structure having a hollow area with therein an elongate pipe entering at a narrow end of said hollow structure; and an entrance into an aperture at a beginning of a narrow end of the hollow area, having a flame interface to an external liquid gas input assembly to the aperture of said pipe. Also, a heating area with the hollow area having a cooking surface temperature at the hollow area within a temperature range of about 1000 to 1200 degrees centigrade; and a ceramic burner slightly above the pipe of the hollow structure, the burner defining a porous honeycomb structure of small holes of at least 1 millimeter in diameter. Further included are about the ceramic burner including a metallic wire of openings of about 1 centimeter above the ceramic burner, the metallic wire known as a soldering board, and each element of the metallic wire each separated by between about 0.5 and about 1.0 centimeters.

### REFERENCE TO RELATED APPLICATION

This application claims the benefit of Application Ser. No. 62/980,590 which was filed on Feb. 24, 2020, and the same is incorporated by reference in its entirety.

### FIELD OF THE INVENTION

This invention relates to an automatic barbequing device having a skewer which rotates in front of a heat source, such as a burner, so that meats, vegetables and food can be easily grilled, roasted or broiled.

### BACKGROUND OF THE INVENTION

A use in barbecuing has the following advantages, with respect to the state of the art in question:
Possibility of performing barbecue with greater efficiency than other equipment;
Possibility for the user to purchase the same product with the highest results at the lowest cost;
Possibility of grilling more quantity and efficiency of food with the same space of other equipment;
Enables gas or energy savings, because the selection of porous honeycomb burners, such as infrared burners or shielded resistance, is made individually;
When using fewer BBQ skewers, you can select only one of the porous honeycomb burners, such as infrared burners or armored resistance, resulting in gas or energy savings;
Ease of access to the interior of the porous honeycomb burner with doors on both sides for maintenance and cleaning;
It allows less space utilization in kitchens, which is an important factor in residences with reduced spaces;
Excellent aesthetic final quality of the barbecue, by the compact, elegant and without projecting elements; and
It allows several options of external finish of the barbecue, being in brushed stainless, satin or painted in epoxy of varied colors.
In terms of Prior Art, the Applicants are unaware of any similar system relative to Rotisserie Gas Burners. However the patents and patent applications known to them are: U.S. Pat. No. 5,676,049A, US 20090000493A1, US 20090020491A1, US 20120234308A1, US 20140212821A1, and WO2013140352A1.

### SUMMARY OF THE INVENTION

A burner for a rotisserie grill provides a rectilinear structure having a hollow area with therein an elongate pipe entering at a narrow end of said hollow structure; and an entrance into an aperture at a beginning of a narrow end of said hollow area, having a flame interface to an external liquid gas input assembly to said aperture of said pipe. Also, a heating area with said hollow area having a cooking surface temperature at said hollow area within a temperature range of about 1000 to 1200 degrees centigrade; and a ceramic base slightly above said pipe of said hollow structure, said base defining a porous honeycomb structure of small holes of at least 1 millimeter in diameter. Further included are about said ceramic base including a metallic wire of openings of about 1 centimeter above the ceramic base, said metallic wire known as a soldering board, and each element of said metallic wire each separated by between 0.5 and 1.0 centimeters.

About the burner is also the quantity of multi-skewers rotating system (See FIG. 1) which also proposes practical improvements, since it is based on the inventive concept of cost-benefit improvement to the user and use, obtaining an equipment with greater functional results, smaller size with more area to use and lower cost.

In order to do so, the present object was developed from the difficulties present in the previous models, mainly in relation to cost reduction, space feasibility for the roast, use of thus taking advantages of the heating system with the porous honeycomb burner or armored resistance.

As a consequence, with the use of roast of both sides contains internal constructive form that allows insertion of the skewers in the rotating device, using as rotary micromotor or systems of gears, it is possible to still select only one of the porous honeycomb burners, burners infrared or shielded resistance, reducing the consumption of gas or energy.

The use of the grill with the roast saves time and more grilling and using less space on the part of the user, bringing better results.

Thus, a modification was developed in the construction of the device, resulting in a single device that includes a multi-barbecue where both sides of its construction yet provide an easy to use and install device, durable and efficient.

Accordingly, it is a further object of the present invention to provide an infrared gas grill which will heat up quite rapidly, providing uniform heat for cooking foods and will rapidly and evenly cook meats and other food items.

Another object of the present invention is to provide a grill which is convenient to use, easy to maintain and provides a superior cooked product in a short period of time.

Another object of the present invention is to provide an infrared radiant grill in which much of the grease from the food may be burned and vaporized, thereby imparting flavor to the meats or food and also driving off a portion of this grease so that it does not collect inside the grill.

An object of the invention is to provide a grill which has a long useful life and is made up of components which are readily and easily replaceable.

A yet object of the present invention is to provide a gas or electric grill which is self-contained and requires little maintenance.

Another still object of the invention is to provide a process for cooking meats, which process is easily and conveniently carried out and will provide cooked meats which are tasty in short periods of time, preserving many of the juices within the meat.

Other objects feature and advantages of the present invention will become apparent from the following description when taken into conjunction with the accompanying drawings wherein like characters of reference designate corresponding parts throughout the several views.

### BRIEF DESCRIPTION OF THE DRAWINGS

FIG. 1 is a perspective view of the complete rotisserie grill.

FIG. 2 is an end view of the outside of the burner system.

FIGS. 3A, 3B and 3C are side, top and end diagrammatic views of the burner.

FIG. 4 is an internal view of the inner cylindrical structure of the burner.

FIG. 5 is a perspective view of the external components of the natural and liquid gas compressed and ignition areas of the system.

FIG. 6 is a view of FIG. 5 however also including the upper area of the burner.

FIG. 7A is an enlarged view of the part of FIG. 5 showing a flame sensor or spark plug from which the above ignition of the liquid gas ignites to the aperture at the input of FIG. 2.

FIG. 7B is an enlarged view of the spark plug or sparkler by which the flame sensor is initiated.

FIG. 7C is a view of the valve gas control.

FIG. 8A is a view of the ceramic honeycomb porous burner also shown at the top of FIG. 2.

FIG. 8B is an enlarged view of FIG. 8A.

FIG. 9 is an enlarged view of the soldering board located above the ceramic base.

### DETAILED DESCRIPTION OF THE INVENTION

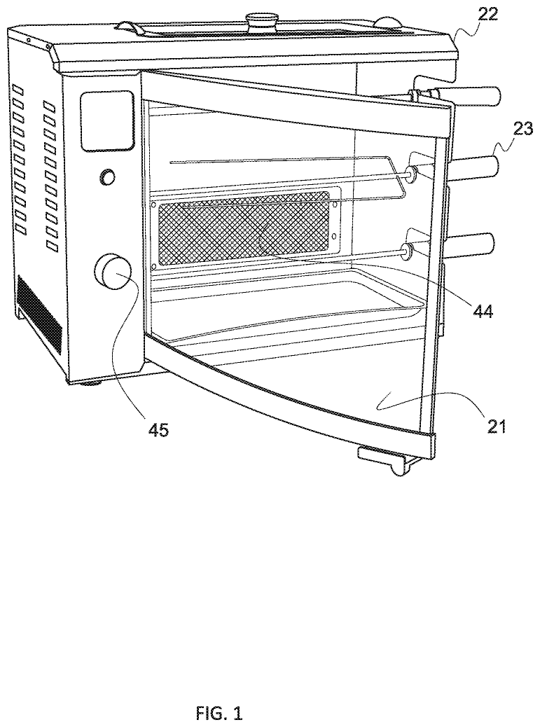

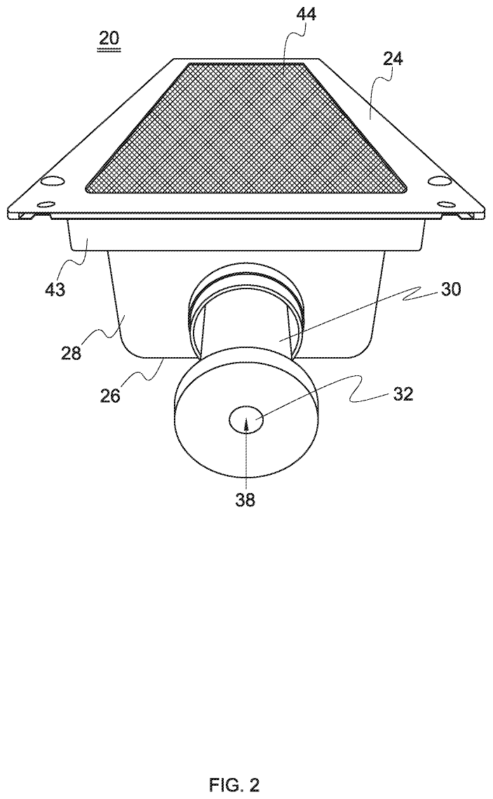

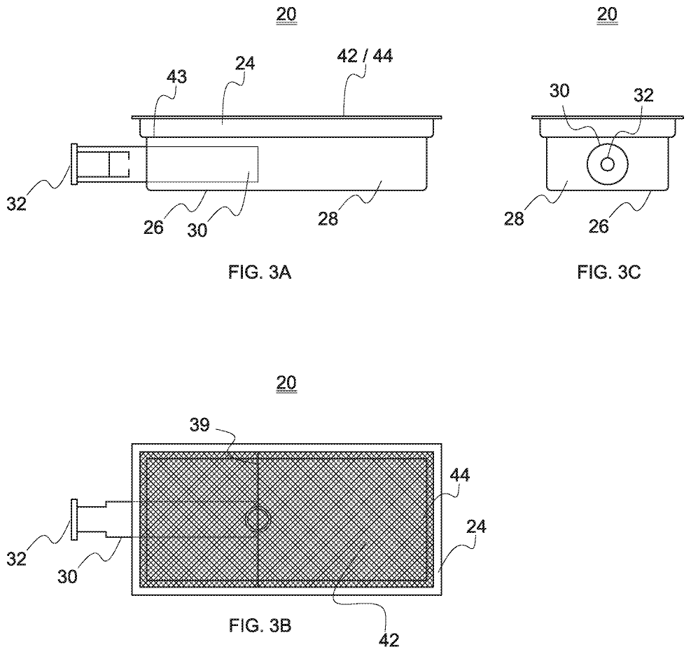

Provided is a rectilinear structure 20/22 in FIG. 1 which shows the location of the burner of the rotisserie system. Said system includes a burner 44, of wood handle 23, and about a vertical volume or region 28. See FIG. 2. Also shown are inner external surface 24 of regions and under area 30. See FIGS. 2 and 3. The general dimensions of the volume of the burner 20 is shown in FIGS. 3A, 3B and 3C.

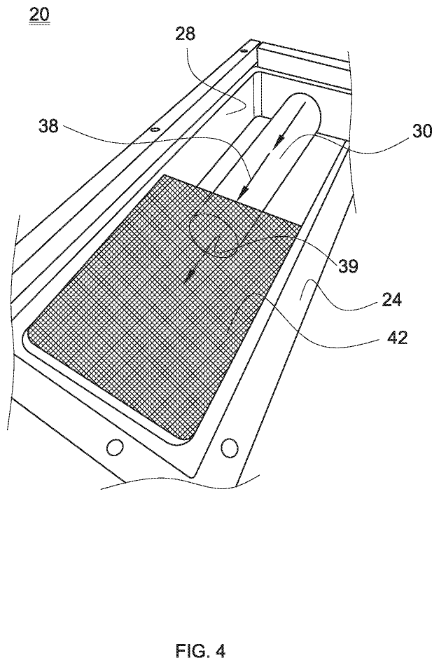

Including in FIGS. 3 A-C and 4 said hollow internal region 28 of external surface 24 and within said lower region 26 shown in said FIG. 3C. Said hollow region 28 provides a basis of an elongate pipe 30 that provides the end of an inner aperture 32. (See FIG. 2 and FIG. 3) of pipe 30 (see also FIGS. 3A and 3B). Element 42 is a screen that covers the outer part of the inner area of burner 20. See FIG. 4

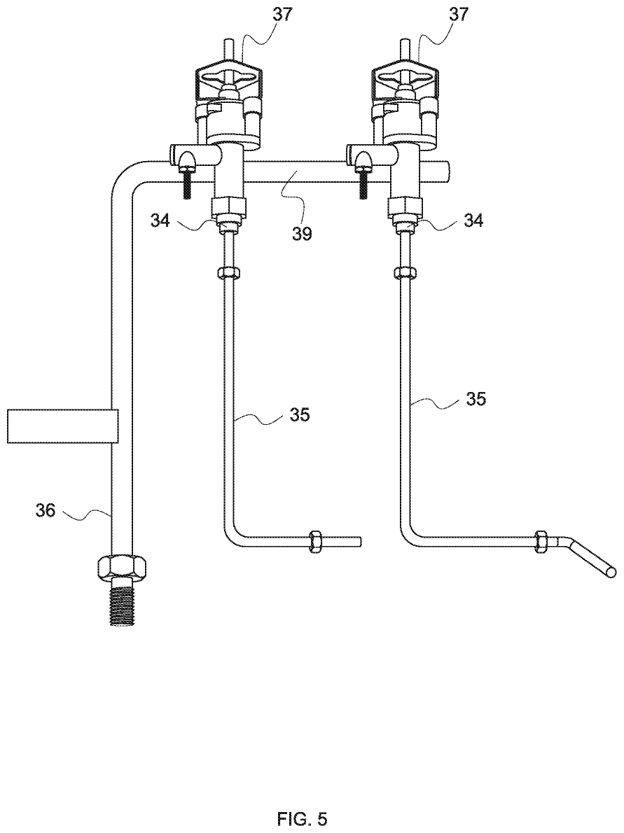

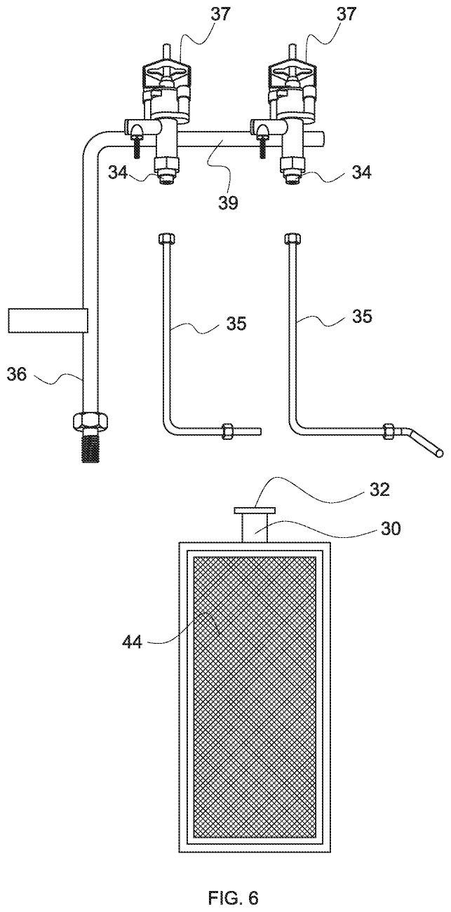

Provided is external top surface 24 of the horizontal volume of the burner 20 above. Within the natural or liquid synthetic (propane) gas will be ignited by a gas valve 34 (see FIG. 5-6) in connection 35 from a liquid gas outlet 36 from a connection about an external use gas provided at the aperture 32 of pipe 30. See FIG. 2.

In FIGS. 5, 6 and 7C are also shown the assembly between the liquid gas valve 36 to the ignited gas valve 34 (see FIGS. 5 and 6). Therein are related aspects 37 and 39 of said valve 34. From that location of the ignited gas valve 34 (see also white line 38 of FIG. 4) continuing within pipe 30 to about the middle of the inner region 28 of the outer surface 24 of the burner (see FIGS. 3, 4 and 5).

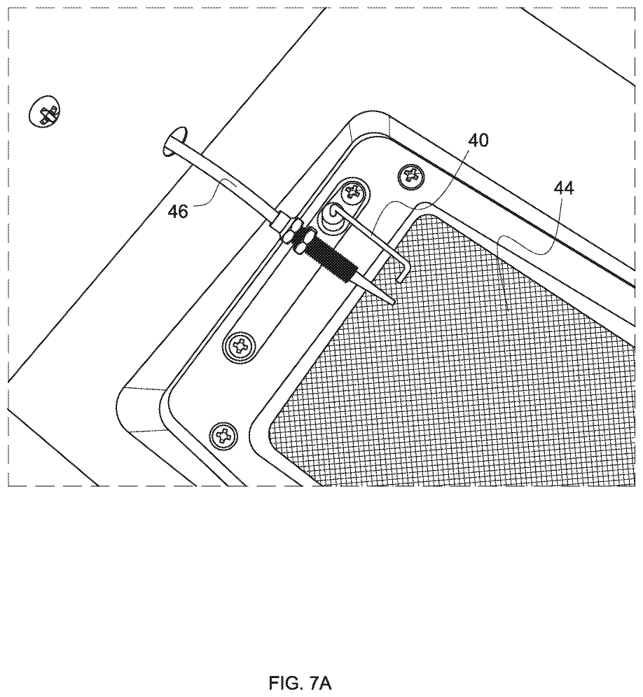

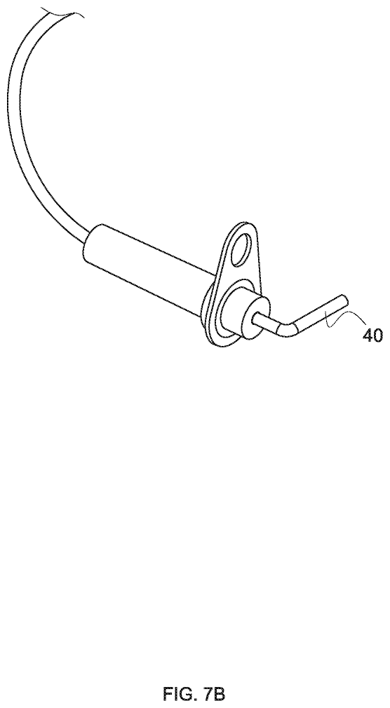

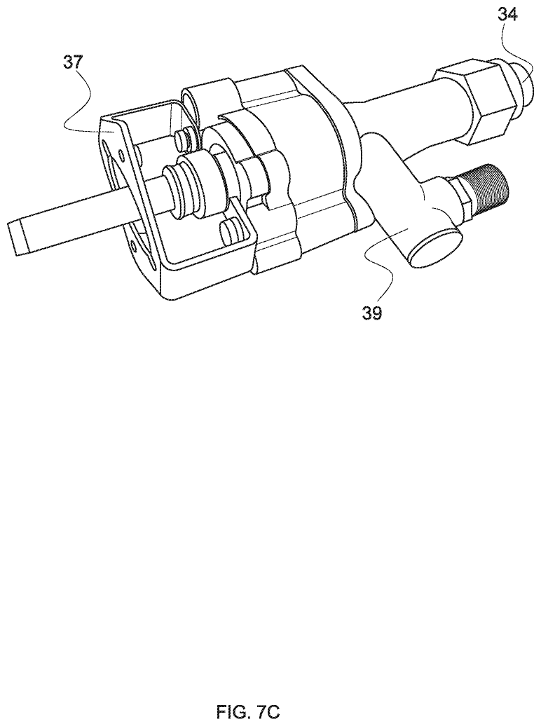

In FIGS. 7A and 7B are shown a flame sensor that operates a spark plug, flame sensor or sparkler 40 to enable liquid gas flow 38 (See FIGS. 4-6) to ignite the gaseous gas against gas valve 34 and therefrom to aperture 32 and then into pipe 30. Therein, the flame sensor or sparkler 40, operates to ignite the gas that is advancing out of the burner 44. Then the gas continues to the inside of the pipe 30 of the hollow region 28 (see FIG. 4) which eventually fills the gas to a temperature of 1000-1200 degrees Centigrade which is the necessary cooking surface for the burner about that region of pipe 30 and outside or line 38 there is provided the screen 42 (FIG. 4) that functions to provide dirt and debris from the gas that might contaminate the top of the hollow region 28 of the upper surface 24 (see FIGS. 3 to 4).

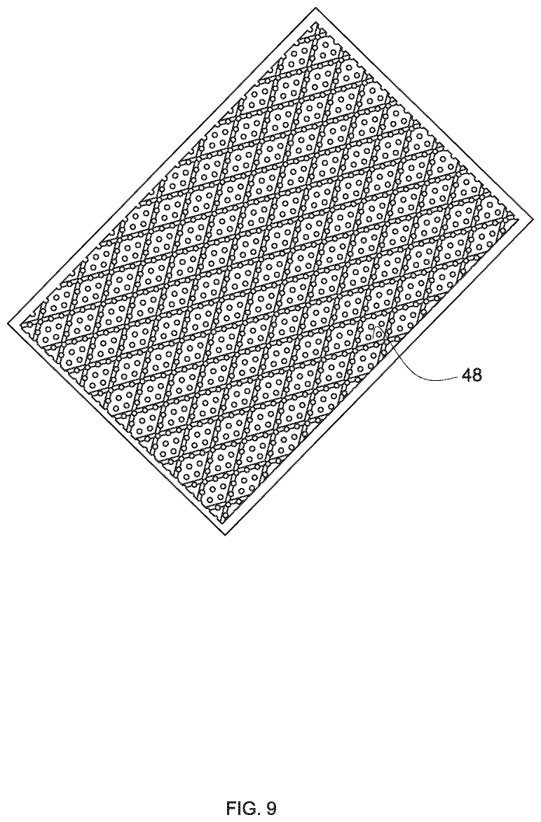

Above the burner 44 is provided a wire upper detector 46 (see FIG. 7A) that is used of either aluminum or stainless steel. This surface is called a soldering board 48 (see FIG. 9) and is provided with triangular wires having a width of about one centimeter above burner 44 and having said wires of about 1.0 centimeters by about 0.75 centimeters, thus forming a triangular structure. Also, the soldering board 48 also acts to limit the use of heated food within the ceramic base above.

Note that FIG. 7C represents a valve gas control 34. This part is the controller (not shown) of the sparkler 40 and gas flow 36/38. When one pushes the button 45, it turns on the sparkler.

### Lighting the Appliance:

1. Make sure the glass door 21 is closed (see FIG. 1), then to ignite burner 44, starts with an upper aspect of the burner, push the burner knob 45 in and slowly rotate counterclockwise to a higher position.
2. You will hear a loud click as the electronic lighter produces a flame sensor or sparkler 40 (see FIG. 7A). Listen for the sound of the gas igniting 34 (FIG. 5-6) and look for a flame 39 (FIG. 4) through the burner. If the burner does not light on the first try, repeat immediately. (For rear burner, a slower turn of the knob 45 is necessary.) This allows gas to accumulate in a further of the burner to achieve ignition.
3. If the burner does not light in 5 seconds, then wait five minutes until the gas clears before attempting to light again. Repeat the procedure or try the manual lighting procedure below.
4. Upon successful lighting, repeat the process on the other burners (if any) you wish to light.
5. To shut off the burner, rotate the knob 45 and turn to OFF.
6. It is normal to hear a popping sound when the burner (s) are turned off.

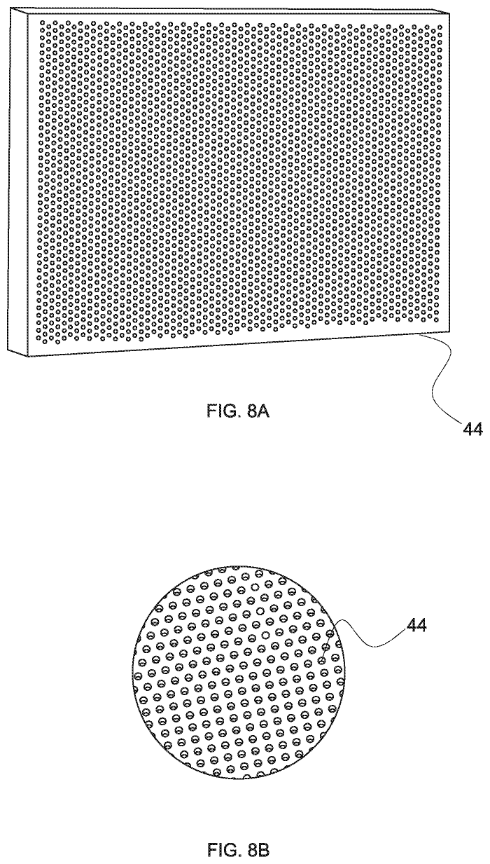

Also provided is a porous ceramic honeycomb burner 44 (FIGS. 2, 6 and 7) and as also shown in FIG. 8A which consists of a combination of ceramic and cordierite stone which also includes the parameters of:

Water absorption 50.4%

Open porosity 61%

Specific gravity 0.5-0.9 g/cm3

Thermal expansion coefficient 1.5-3(3×10-6K-1)

Temperature softening >1280 degrees centigrade

Cooking surface temperature 1000-1200 degrees centigrade

CO2 release ≤0.006%

NOx release ≤5 ppm

Diameter of minimal holes 1 mm

The above is known as said honeycomb structure/burner 44 which provides energy saving, heating up fast, high heat value, saving more than 40% with gas. Honeycomb structure Using a porous ceramic plate as burner, combustion infrared radiation has strong penetrating power. The structure of small honeycomb-like holes reduces surface contact between metal and the board.

As such, the ceramic burner 44, is capable of very high temperatures while requiring width of only about 13 millimeters. The maximum temperature of the burner is about 1280 degrees centigrade. Also, a typical dimension of the ceramic burner is about 135 millimeters of length and 95 millimeters of width (see FIGS. 2, 3 and 8A). The burner 44 also provides a metal heat detector 46 (see FIG. 7A) so that the heat of the burner 44 will not exceed the heat of 1200 degrees centigrade at which the use of food thereon may begin to burn from the grill or grill material. The heat detector 46 also generates the spark that ignites the gas. The use of the burner also provides a uniform heating temperature of the entire hollow internal region 28. (See FIG. 2).

In summary a system for a rotisserie grill, comprising a structure having a hollow area with therein an elongate pipe 30 entering at a narrow end of the hollow region 28; an entrance into the aperture 32 at a beginning of a narrow end of the hollow region 28, having a flame interface to an external liquid gas input assembly to the aperture of the pipe 30; a heating area with the hollow region 28 having a cooking surface temperature at the hollow area within a temperature range of about 1000 to about 1200 degrees Centigrade; the ceramic burner 44 slightly above the pipe 30 of the hollow region 28, the base defining a porous honeycomb structure of burner 44 of small holes of at least about 1 millimeter in diameter; and about the ceramic burner 44 including a wire of openings above the ceramic burner 44, the wire including the soldering board 48, and each opening of the wire each separated by between about 0.5 and about 1.0 centimeters. A screen within the hollow region 28 of the volume of rotisserie used about an outer portion of the pipe, the screen continuing to an end of the hollow region 28 and external an inner end of the aperture 32 of the pipe. A flame sensor or sparkler 40 between the flame interface between the external liquid gas input assembly (see FIG. 7C) and the aperture 32 of the input of the elongate pipe 30 of the hollow region 28.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth herein.

We claim:

1. A system for a rotisserie grill, comprising:
(a) a structure having a hollow area with therein an elongate pipe entering at a narrow end of said hollow area;
(b) an entrance into an aperture at a beginning of a narrow end of said hollow area, having a flame interface to an external liquid gas input assembly to said aperture of said pipe;
(c) a heating area with said hollow area having a cooking surface temperature at said hollow area within a temperature range of about 1000 to about 1200 degrees Centigrade;
(d) a ceramic burner slightly above said pipe of said hollow structure, said base defining a porous honeycomb structure of small holes of at least about 1 millimeter in diameter; and
(e) about said ceramic burner including a wire of openings above the ceramic burner, said wire including a soldering board, and each opening of said wire each separated by between about 0.5 and about 1.0 centimeters.

2. The system of the burner as recited in claim 1, comprising:
a screen within said hollow area of said volume of rotisserie used about an outer portion of said pipe, said screen continuing to an end of said hollow area and external an inner end of said aperture of said pipe.

3. The system of the burner as recited in claim 2, comprising:
a spark plug or flame sensor between the flame interface between the external liquid gas input assembly and said aperture of said input of the elongate pipe of the hollow area.

4. The system as recited in claim 2, said ceramic burner also includes a composition of cordierite stone.

5. The system as recited in claim 4, in which a temperature softening occurs at about 1280 degrees centigrade.

6. The system as recited in claim 4, in which an open porosity of said composition is that of about 61 percent.

7. The system as recited in claim 4, in which a specific gravity of said composition of said honeycomb structure is between 0.6 to 0.9 grams/cm3.

8. The system as recited in claim 4, in which a release of carbon dioxide is equal or less than 0.006 percent.

9. The system as recited in claim 3, in which said soldering board comprises:
a smokeless item relative to a base of said ceramic burner.

10. The system as recited in claim 3, comprises:
an automatic ignition.

11. The system as recited in claim 3 in which said wire as said burner comprises:
a metallic wire.

12. The system as recited in claim 11, said opening of said wire, comprises:
an element of said opening of said metallic wire.

13. The system as recited in claim 2 in which said flame interface comprises:
a flame sensor.

14. The system as recited in claim 2 in which said flame interface comprises:
a spark plug.

15. The system as recited in claim 13, comprises:
said claim sensor defined an ignition of said liquid gas assembly and thereby to the aperture of said pipe of said structure of the system.
